(19) United States
(12) Patent Application Publication
(10) Pub. No.: US 2022/0242611 A1
(43) Pub. Date: Aug. 4, 2022

(54) RADIO FREQUENCY IDENTIFICATION GASKET FOR SEALING BOTTLE MOUTH

(71) Applicant: YNB SUPPLY (ASIA) CORPORATION, New Taipei City (TW)

(72) Inventor: YEN-WU YANG, New Taipei City (TW)

(21) Appl. No.: 17/727,851

(22) Filed: Apr. 25, 2022

Related U.S. Application Data
(63) Continuation of application No. 16/695,943, filed on Nov. 26, 2019.

(51) Int. Cl. B65D 17/34

(52) U.S. Cl. CPC B65D 17/34; B65D 2517/0013

(57) ABSTRACT

A radio frequency identification gasket for sealing a bottle mouth has an adhesive layer, an aluminum-plastic film layer, a radio frequency identification layer and a composite film functional layer from bottom to top, wherein the composite film functional layer is formed with a reserved structural weakening zone therein, the radio frequency identification layer is set with a structure of a radio frequency identification antenna line that is destroyed when the composite film functional layer is torn. The composite film functional layer forms the reserved structural weakening zone therein through physical treatment, and the physical treatment is one of die micro-pressing, laser micro-cutting or electron beam micro-cutting. The radio frequency identification gasket is mounted in the bottle mouth and has the functions of sealing and reading and writing radio frequency tags, and also has an anti-counterfeiting effect.

### CROSS-REFERENCE TO RELATED APPLICATION

This application is a continuation application of U.S. application Ser. No. 16/695,943 filed on Nov. 26, 2019, the entire contents of which are hereby incorporated by reference for which priority is claimed under 35 U.S.C. § 120.

### BACKGROUND OF THE INVENTION

### 1. Field of the Invention

The present disclosure relates to the technical field of packaging, and more specifically to a radio frequency identification gasket for sealing a bottle mouth.

### 2. Description of the Related Art

In the prior art, many fields involve sealing bottle mouth for quality assurance, anti-counterfeiting, radio frequency identification, production history record, storage and transportation logistics, and tracking. At present, some medicine bottles, wine bottles, and food cans on the market use tags with radio frequency reading and writing functions (i.e., RFID tags). Although RFID tags are convenient to use, they are easy to remove and use for the second time due to the convenience of sticking. Some criminals may use the radio frequency tags twice by removing and attaching them to the fake medicine bottle and fake wine bottle, resulting in poor safety of the radio frequency tags used. Therefore, only the one-dimensional code serial number or the two-dimensional code serial number outside the container is used to check the anti-counterfeiting, but it is often difficult to detect when it has been unpacked. The effective RFID tag must be maintained until the consumer purchases the product, and the RFID tag can be achieved for one-time use.

How to check the radio frequency identifier (i.e., RFID tag) in the sealed bottle mouth of the product with the radio frequency identification serial number outside the container for anti-counterfeiting before unpacking the product in each part of the factory, warehouse, logistic, wholesale or retail, and at the same time ensure that the radio frequency identifier is one-time use is the problem to be solved by the present disclosure.

### BRIEF SUMMARY OF THE INVENTION

The objective of the present disclosure is to provide a radio frequency identification gasket for sealing a bottle mouth, which is mounted in the bottle mouth and has the functions of sealing and reading and writing radio frequency tags, and also has an anti-counterfeiting effect.

To achieve the above objective, the solution of the present disclosure is: A radio frequency identification gasket for sealing a bottle mouth, the gasket comprises an adhesive layer, an aluminum-plastic film layer, a radio frequency identification layer and a composite film functional layer from bottom to top, wherein the composite film functional layer is formed with a reserved structural weakening zone therein, the radio frequency identification layer is set with a structure of a radio frequency identification antenna line that is destroyed when the composite film functional layer is torn.

The composite film functional layer forms the reserved structural weakening zone therein through physical treatment, and the physical treatment is one of die micro-pressing, laser micro-cutting or electron beam micro-cutting.

The structural weakening zone is one of a thinned band, a solid line, a dashed line, a dotted line, a bead line, a tangent line or a pressure groove.

The shape of the structural weakening zone is one of an involute shape, a spiral shape, a cycloid shape, a strip shape, a V shape, a U shape, a W shape or a parallel linear shape.

A side of the gasket is extended to form a lug part, and the lug part is set to go with the structural weakening zone.

The shape of the lug part is semicircular, semicircular arc, V-shaped, square, irregular or polygonal shape.

The radio frequency identification layer comprises a radio frequency identifier, a radio frequency identification antenna line, and a conductive line attached to a cladding material.

The material of the cladding material is one of polyethylene, polyethylene terephthalate, polypropylene or paper.

The material of the composite film functional layer is a composite of two of polyethylene, polyethylene terephthalate, polypropylene or paper.

After adopting the above structure, the gasket for sealing of the present disclosure forms a multi-layer structure, so that it can systemically integrate the comprehensive functions of sealing bottle mouth for quality assurance, anti-counterfeiting, radio frequency identification, production history record, storage and transportation logistics, and tracking, and when the gasket is torn apart, the structure of the original radio frequency identification antenna line in the gasket will be destroyed, making it extremely difficult to read the radio frequency identifier, thus achieving the anti-counterfeiting effect.

### BRIEF DESCRIPTION OF THE DRAWINGS

FIG. 1 is a schematic view of a front structure of the present disclosure.

FIG. 2 is a schematic view of a cross-sectional structure of the present disclosure.

FIG. 3 is a schematic view of the layer structure of the present disclosure.

### DETAILED DESCRIPTION OF THE INVENTION

In order to further explain the technical solution of the disclosure, the disclosure is described in detail below through specific embodiments.

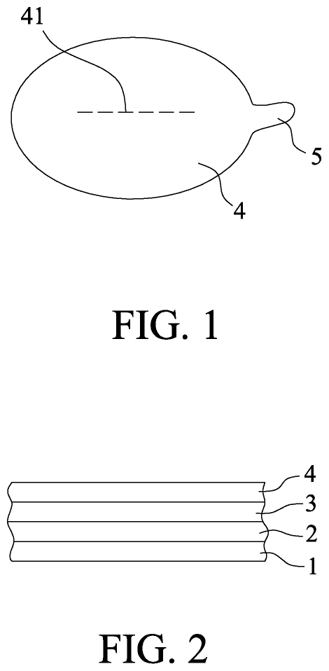

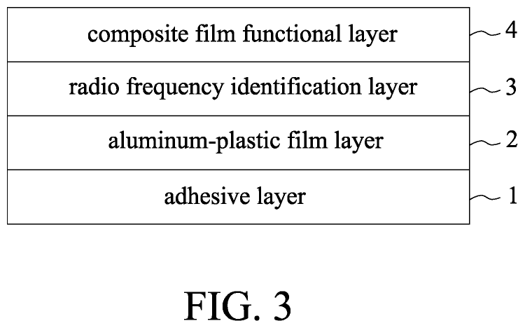

As shown in FIGS. 1 to 3, the present disclosure discloses a RFID gasket for sealing a bottle mouth, which is adhered and fixed on the bottle mouth or other container mouths to seal the bottle mouth or opening. In order to enable the gasket to integrate the comprehensive functions of sealing bottle mouth for quality assurance, anti-counterfeiting, radio frequency identification, production history record, storage and transportation logistics, and tracking, the gasket of the present disclosure comprises an adhesive layer 1, an aluminum-plastic film layer 2, a radio frequency identification layer 3 and a composite film functional layer 4 from bottom to top.

When used, the adhesive layer 1 is adhered on the bottle mouth, and the radio frequency identification layer 3 is provided with a radio frequency identifier therein. The radio frequency identification layer 3 may comprise a radio frequency identifier, a radio frequency identification antenna line, and a conductive line attached to a cladding material (not shown in the figures). The material of the cladding material may be one of polyethylene (PE), polyethylene terephthalate (PET), polypropylene (PP) or paper. In the sealing process, the container is filled with the filled stuff in the customer's factory, and after the bottle mouth is sealed by an electromagnetic induction sealing machine, a production on-line RFID automatic reader is used to read the radio frequency identifier in the radio frequency identification layer 3 of the gasket, and automatically input the good production history data file, and then production on-line automatically convert the radio frequency identifier to print the radio frequency identification serial number in a prominent position outside the container (lid, bag or box) to complete the production history database anti-counterfeiting identification file of the factory side. Before unpacking the product in each part of the factory, warehouse, logistic, wholesale or retail, the anti-counterfeiting is checked by the radio frequency identifier 3 in the gasket of the product and the radio frequency identification serial number outside the container.

The composite film functional layer 4 is further provided on the radio frequency identification layer 3, and the material of the composite film functional layer 4 is a composite of two of polyethylene, polyethylene terephthalate, polypropylene or paper. In order to ensure the one-time use of the radio frequency identifier, in the present disclosure, the composite film functional layer 4 is formed with a reserved structural weakening zone 41 therein, and the structural weakening zone 41 can be exactly located on the radio frequency identification antenna line in the radio frequency identification layer 3, so that it can drive a structure of the radio frequency identification antenna line in the radio frequency identification layer 3 to be destroyed when the composite film functional layer is torn. For the structural weakening zone 41, it can be formed on the composite film functional layer 4 through physical treatment, and a method of the physical treatment may be one of die micro-pressing, laser micro-cutting or electron beam micro-cutting. The structural weakening zone 41 may be one of a thinned band, a solid line, a dashed line, a dotted line, a bead line, a tangent line or a pressure groove. The shape of the structural weakening zone 41 may be one of an involute shape, a spiral shape, a cycloid shape, a strip shape, a V shape, a U shape, a W shape or a parallel linear shape. With the arrangement of the structural weakening zone 41, when the gasket is torn, a tearing force of the composite film functional layer 4 can drive to extremely easy destroy the structure of the original radio frequency identification antenna line in the radio frequency identification layer 3 of the gasket, and thus the radio frequency identifier cannot be read again in order to achieve the anti-counterfeiting effect.

Furthermore, a side of the gasket of the present disclosure can also be extended to form a lug part 5, the lug part 5 is arranged on the side of the overall appearance of the gasket, and the shape of the lug part 5 may be semicircular, semicircular arc, V-shaped, square, irregular or polygonal shape, so as to facilitate the gasket for sealing to be torn apart. The lug part 5 is set to go with the structural weakening zone 41, when the lug part 5 is pulled by a hand to tear the gasket and unpack the product, the tearing force of the composite film functional layer 4 can destroy the structure of the original radio frequency identification antenna line in the radio frequency identification layer 3, resulting in extremely difficult to read the radio frequency identifier, thereby achieving the anti-counterfeiting effect.

After adopting the above structure, the radio frequency identification gasket for sealing a bottle mouth of the present disclosure is used as a gasket for sealing, and forms a multi-layer structure, so that it can systemically integrate the comprehensive functions of sealing bottle mouth for quality assurance, anti-counterfeiting, radio frequency identification, production history record, storage and transportation logistics, and tracking, and when the gasket is torn apart, the structure of the original radio frequency identification antenna line in the gasket will be destroyed, making it extremely difficult to read the radio frequency identifier, thus achieving the anti-counterfeiting effect.

The above-mentioned embodiments and drawings do not limit the product form and style of the present disclosure, and any appropriate changes or modifications made by a person of ordinary skill in the art shall be regarded as not departing from the scope of the present disclosure.

What is claimed is:

1. A radio frequency identification gasket for sealing a bottle mouth, comprises an adhesive layer, an aluminum-plastic film layer, a radio frequency identification layer and a composite film functional layer from bottom to top, wherein the composite film functional layer is formed with a reserved structural weakening zone therein, the radio frequency identification layer is set with a structure of a radio frequency identification antenna line that is destroyed when the composite film functional layer is torn.

2. The radio frequency identification gasket for sealing a bottle mouth according to claim 1, wherein the composite film functional layer forms the reserved structural weakening zone therein through physical treatment, and the physical treatment is one of die micro-pressing, laser micro-cutting or electron beam micro-cutting.

3. The radio frequency identification gasket for sealing a bottle mouth according to claim 1, wherein the structural weakening zone is one of a thinned band, a solid line, a dashed line, a dotted line, a bead line, a tangent line or a pressure groove.

4. The radio frequency identification gasket for sealing a bottle mouth according to claim 2, wherein the structural weakening zone is one of a thinned band, a solid line, a dashed line, a dotted line, a bead line, a tangent line or a pressure groove.

5. The radio frequency identification gasket for sealing a bottle mouth according to claim 3, wherein the shape of the structural weakening zone is one of an involute shape, a spiral shape, a cycloid shape, a strip shape, a V shape, a U shape, a W shape or a parallel linear shape.

6. The radio frequency identification gasket for sealing a bottle mouth according to claim 4, wherein the shape of the structural weakening zone is one of an involute shape, a spiral shape, a cycloid shape, a strip shape, a V shape, a U shape, a W shape or a parallel linear shape.

7. The radio frequency identification gasket for sealing a bottle mouth according to claim 1, wherein a side of the gasket is extended to form a lug part, and the lug part is set to go with the structural weakening zone.

8. The radio frequency identification gasket for sealing a bottle mouth according to claim 7, wherein the shape of the lug part is semicircular, semicircular arc, V-shaped, square, irregular or polygonal shape.

9. The radio frequency identification gasket for sealing a bottle mouth according to claim 1, wherein the radio frequency identification layer comprises a radio frequency identifier, the radio frequency identification antenna line, and a conductive line attached to a cladding material.

10. The radio frequency identification gasket for sealing a bottle mouth according to claim 9, wherein the material of the cladding material is one of polyethylene, polyethylene terephthalate, polypropylene or paper.

11. The radio frequency identification gasket for sealing a bottle mouth according to claim 1, wherein the material of the composite film functional layer is a composite of two of polyethylene, polyethylene terephthalate, polypropylene or paper.
